(19) United States
(12) Patent Application Publication
(10) Pub. No.: US 2020/0326814 A1
(43) Pub. Date: Oct. 15, 2020

(54) SYSTEM AND METHODS FOR HUMAN COMPUTER INTERFACE IN THREE DIMENSIONS

(71) Applicant: Intel Corporation, Santa Clara, CA (US)

(72) Inventor: Tuotuo Li, Santa Clara, CA (US)

(21) Appl. No.: 16/704,276

(22) Filed: Dec. 5, 2019

(51) Int. Cl. G06F 3/042; G06T 7/60

(52) U.S. Cl. CPC G06F 3/0425; G06T 7/60

(57) ABSTRACT

In one embodiment, the present disclosure pertains to human-computer interfaces. In one embodiment, a method includes an operation for detecting an optical signal emitted from an object on a surface. The optical signal forms a geometric pattern on the surface. The method also includes an operation for determining a three-dimensional position of the object relative to the surface based on the geometric pattern. In some embodiments, a plurality of angles and distances are determined from the geometric pattern. The angles and distances correspond to geometric shapes formed between the object and the surface as defined by the geometric pattern. The three-dimensional position may be determined based on the angles and distances.

### BACKGROUND

The present disclosure relates to human-computer interfaces (HCI), and in particular, to three-dimensional (3D) human-computer interface systems and methods.

Humans interact with computers using a variety of input devices. For example, users may interact with their computers using a mouse, a keyboard, stylus, joystick, finger touch, etc. Many of the current input methods involve translating two-dimensional input coordinates to a two-dimensional application environment, for example in word processing, email applications, internet browsers, etc. In other instances, two-dimensional input coordinates are mapped to a three-dimensional environment on the computer. This occurs, for example, in 3D games, computer-aided design, and 3D visual effects software, among others. For these applications, two-dimensional (2D) inputs (e.g., moving a mouse) and one-dimensional (1D) inputs (e.g., scrolling of the mouse wheel) must be combined to give rise to the effect of 3D input, which can have limited functionality and usability.

In some instances, 3D input may be tracked via camera and subsequent image processing. However, such 3D input processing is computationally expensive and lacking in accuracy. There is thus a need for and benefit to improving HCI in 3D.

The present disclosure provides techniques for improving HCI in 3D.

### SUMMARY

In one embodiment, a method is described for recovering the pose of an HCI object. The method includes detecting an optical signal emitted from an object and received by an optical sensor on a surface. The optical signal forms a geometric pattern on the surface. In one example embodiment, an optical sensor on the surface may include an array of phototransistors that are configured to detect the geometric pattern. The method also includes determining, based on the geometric pattern, a three-dimensional position of the object relative to the surface.

The following detailed description and accompanying drawings provide a better understanding of the nature and advantages of the present disclosure.

### BRIEF DESCRIPTION OF THE DRAWINGS

FIG. 1 illustrates a user interacting with a computer in 3D via stylus, according to one embodiment.

FIGS. 2A-2F illustrate examples of how 3D movements in real world space are translated to changes in application space, according to one embodiment.

FIG. 3 illustrates a stylus emitting an optical signal producing a geometric pattern on a surface of an optical sensor and the geometric shapes formed between the stylus and the surface, according to one embodiment.

FIGS. 4A-4F illustrate various beam shapes that may be emitted from the stylus and various resulting geometric patterns formed on surfaces.

FIG. 5 illustrates a method of recovering the pose of the stylus, according to one embodiment.

FIG. 6 illustrates how the optical sensor comprising an array of phototransistors is used to extrapolate the geometric pattern formed on the optical sensor, according to one embodiment.

FIG. 7 illustrates components of an object that emits an optical signal and that may be used with the present embodiment, according to one embodiment.

FIG. 8 illustrates an overall flow of a method for recovering the pose of an object used for HCI in 3D, according to one embodiment.

FIG. 9 shows encoding messages within the optical signal emitted by the stylus, according to one embodiment.

FIG. 10A shows a cross-sectional view of a computing device used for HCI in 3D, according to one embodiment.

FIG. 10B shows a plot of optical sensor sensitivity and transmission properties of a filter that may be installed on top of the optical sensor, according to one embodiment.

FIG. 11 shows components of a computing device used to implement the various embodiments described here.

### DETAILED DESCRIPTION

In the following description, for purposes of explanation, numerous examples and specific details are set forth in order to provide a thorough understanding of the present disclosure. Such examples and details are not to be construed as unduly limiting the elements of the claims or the claimed subject matter as a whole. It will be evident to one skilled in the art, based on the language of the different claims, that the claimed subject matter may include some or all of the features in these examples, alone or in combination, and may further include modifications and equivalents of the features and techniques described herein.

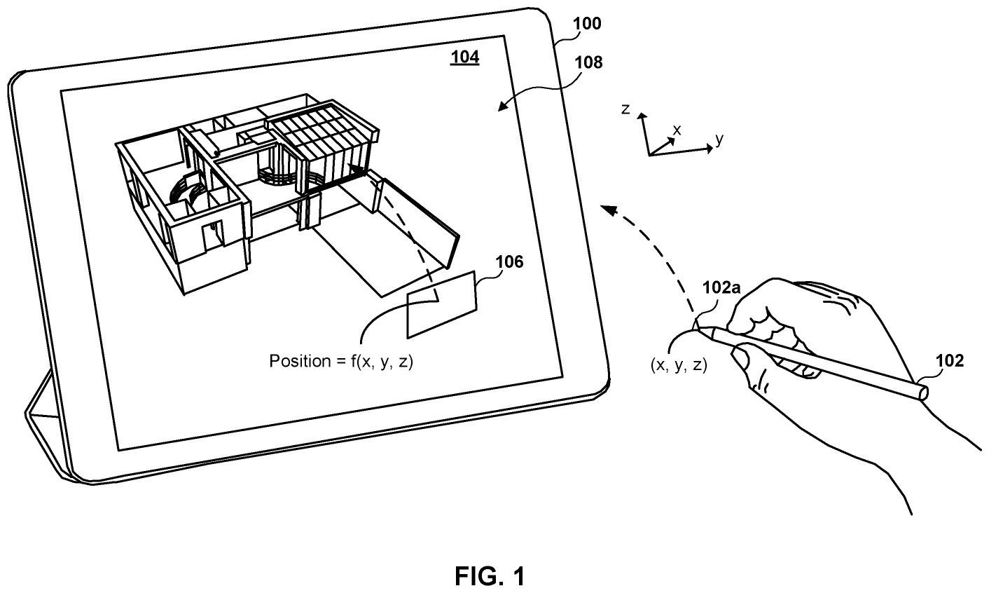

FIG. 1 illustrates a user interacting with computing device 100 in 3D via an HCI object 102, according to one embodiment. In the embodiment shown, the computing device 100 is a tablet, while the HCI object 102 resembles a stylus. In this example, the user is shown to be interacting with a 3D modeling software in which a virtual object 106 is being controlled by the user via the HCI object 102. The user is shown to be able to move the virtual object 106, which is a window pane, toward a 3D house by moving the HCI object 102 in the desired direction. Namely, the user is illustrated to move the HCI object 102 in the forward direction (e.g., −x direction) and in the upward direction (e.g., +z direction). In doing so, the virtual object 102 moves in a similar direction within the 3D modeling software. Thus, the position and movement of the HCI object 102 in real world space is mapped to the virtual position and virtual movement of the virtual object 106 in virtual space. For example, if a point 102a of the HCI object 102 has the real-world coordinates of (x, y, z), then the virtual object 106 has virtual coordinates that are a function of (x, y, z). As a result, in this example, the user is advantageously able to interact with the computer application and the computing device in 3D.

In various embodiments, the HCI object 102 produces an optical signal and the computing device includes an optical sensor 108 that is disposed on the display 104 of the computing device 100. The optical signal is configured to emanate from a portion of the HCI object 102, according to some embodiments. For example, in the embodiment shown, the optical signal may emanate from near the point 102a of the HCI object 102 and travel toward the display 104 of the computing device 100. The optical sensor 108 of the computing device 100 detects the optical signal. Based on the shape of the optical signal that is detected, the computing device 100 is able to determine the 3D position of the HCI object 102. In various embodiments, the computing device 100 uses the 3D position of the HCI object 102 as user input into the application that is being executed.

While the present example illustrates certain advantages of the present disclosure to 3D software interfaces, it is to be understood that the present disclosure is applicable to other user interfaces as well (e.g., 2D interfaces).

Additionally, while the present example illustrates the computing device 100 to be a tablet and the optical sensor 108 to be overlaid or embedded on the display 104 of the computing device, other configurations and embodiments are contemplated. For example, the computing device 100 may be a laptop, a desktop, a monitor, a television screen, an interactive whiteboard, a mobile phone, a phablet, among others. Additionally, the optical sensor 108 may incorporated into a trackpad (e.g., of a laptop) that is part of the computing device 100 or embodied into a standalone device.

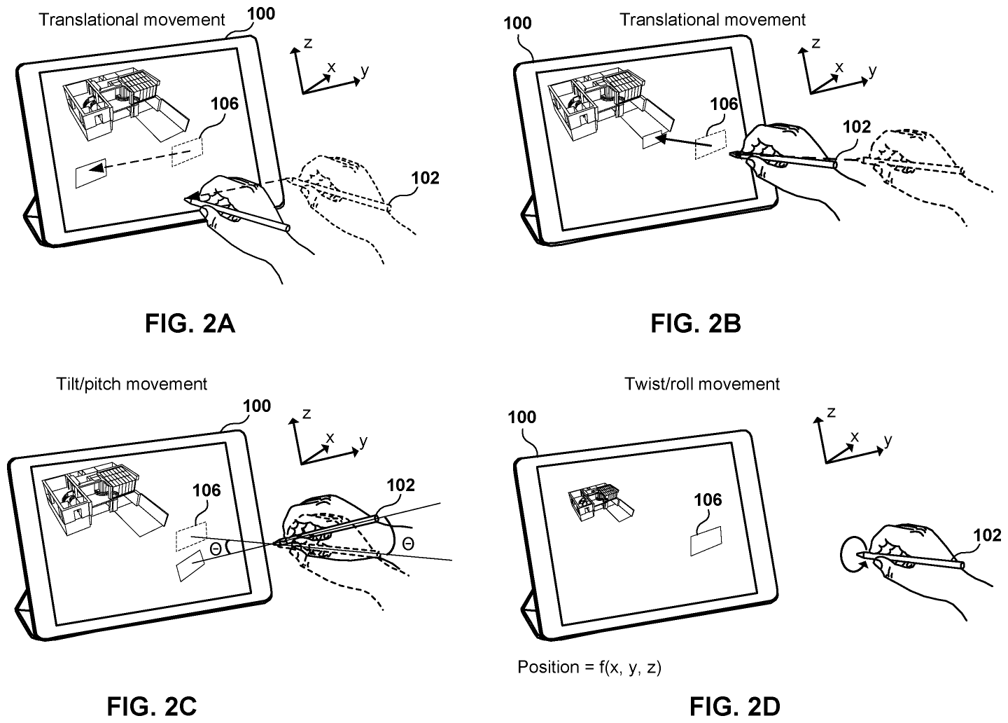

FIGS. 2A-2D illustrate examples of how 3D movements in real world space are translated to changes in application space, according to one embodiment. For example, in FIG. 2A, the user is shown to move the HCI object 102 from the right to left, e.g., in the −y direction where the y axis is parallel to the long axis of the display. As a result, the virtual object 106 is moved in the same direction from right to left. The amount of movement provided to the virtual object 106 may be more, less, or substantially the same as the real-world movement of the HCI object 102. For example, if the HCI object 102 is moved 10 centimeters from right to left, the virtual object 106 may be made to move 10 centimeters in distances on the display. In other embodiments, the amount of movement may be geared such that the virtual object 106 moves more or less than 10 centimeters. In any case, the corresponding movement or displacement of the virtual object 106 is envisioned to be proportional to the real-world movement or displacement of the HCI object 102.

In FIG. 2B, the HCI object 102 is shown to be brought from a position that is further away from the display to a position that is closer to the display. In other words, the user moves the HCI object 102 in the −x direction, where the x axis is normal to the plane defined by the display. As a result of such movement, the virtual object 106 moves in a substantially similar direction in application space, e.g., toward the model house. As noted above, the ratio of real-world displacement of the HCI object 102 and the virtual displacement may vary based on application, user preference, user selection, or automatic “gearing,” among other factors.

In FIG. 2C, the user is shown to have tilted or pitched the HCI object 102 by 0 about the y-axis of a point of the HCI object 102. In other words, the HCI object 102 has been to rotate about the y-axis with the point of HCI object 102 remaining at the same 3D position. As a result, the virtual object 106 is shown to have been rotated and translated in virtual space. According to certain embodiments such as the one illustrated in FIG. 2C, yaw and pitch rotations cause the virtual object 106 to move as though the virtual object 106 orbits HCI object 102 like a kite on a kite string. In other embodiments, yaw and pitch rotations of the HCI object 102 need not provide translational movement to the virtual object 106. In the former case, the axis of rotation of the virtual object 106 runs through a point on the HCI object 102. In the latter case, the axis of rotation of the virtual object 106 can run through the virtual object itself As a result, by pitching the HCI object 102 by Θ, the virtual object 106 would be pitched by Θ without translating the virtual object 106 (e.g., rotate the virtual object 106 about the y-axis of the virtual object 106 by Θ). In still other embodiments, the rotational axis could be placed anywhere else that would produce a desired effect.

In FIG. 2D, the user is shown to twist the HCI object 102. In other words, the roll of the HCI object 102 is changed (e.g., the HCI object 102 is rotated about the x-axis, which runs through the center of the HCI object 102). In some embodiments, this roll input can be used to achieve differing effects in the software application. For example, in the embodiment shown, roll is shown to zoom in or out within the virtual space of the software application. As a result, the model house is shown to be further away than in FIGS. 2A-2C. If the user wishes to zoom back in, they may twist the HCI object 102 in the clockwise direction.

In other embodiments, the roll input may be used rotate the virtual object 106 about the x-axis, which is normal to the plane of the display. For example, if the user changes the roll of the HCI object 102 by 90° in the counter-clockwise direction, the virtual object 106 will likewise be rotated by 90° in the counter-clockwise direction. In other embodiments, a gearing or sensitivity parameter may be applied to the rotation of the HCI object 102 such that the virtual object 106 rotates more or less than 180°.

In still other embodiments, the roll input may be used to control gearing or sensitivity or “speed” of other input, such as changes to 3D position, yaw, and pitch. In many operating systems, there is a setting that controls the speed or sensitivity of how an on-screen object moves relative to an input device, such as a cursor to a mouse or a page scroll to a mouse wheel. It is envisioned that the roll input may be used to adjust the speed or sensitivity of any of the aforementioned movements on-the-fly. For example, a clockwise roll of the HCI object 102 may increase speed or sensitivity while a counter-clockwise roll of the HCI object may decrease the same, or vice versa.

In FIG. 2E a first HCI object 102 and a second HCI object 102′ are shown to be used in conjunction while interacting with an application. A user may hold the first HCI object 102 with their right hand and the second HCI object 102′ with their left hand or vice versa. In the embodiment shown the first HCI object 102 controls a first virtual object 106 while the second HCI object 102′ controls a second virtual object 106′. In other embodiments, the second HCI object 102′ may control some feature of the first virtual object 106, such as a property of the virtual object 106.

In FIG. 2F, a user is shown to be using an HCI object 102 to interact with an augmented reality (AR) or virtual reality (VR) environment 200, according to one embodiment. The AR or VR environment 200 is provided to the user via a head-mounted display (HMD) 201. In the particular embodiment shown in FIG. 2F, AR or VR environment 200 is anchored onto tabletop 208 for a tabletop display, for example. In the embodiment shown, an optical sensor 204 rests on top of the tabletop 204 and receives an optical signal output by the HCI object 102. As a result, the 3D location and orientation of the HCI object 102 may be calculated using the methods described here. The user is shown to control a virtual object 202 by moving the HCI object 102. If the user places the virtual object 202 onto virtual object 206, the user can then control both virtual object 202 and 206 using the HCI object 102. In certain embodiments, a second HCI object (not shown) may be used by the user in their other hand such that they can control two discrete virtual objects simultaneously.

The HMD 201 may take the form of semi-translucent glasses, the lenses of which augmented reality content may be displayed using an embedded display or using projectors that project onto the lenses. In other embodiments, the HMD 201 may take the form of an immersive display that blocks out real-world content.

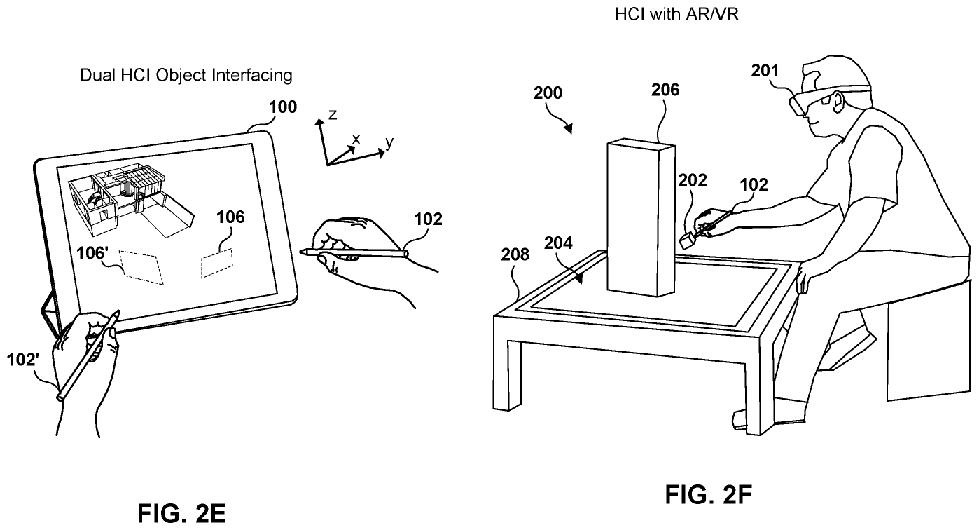

FIG. 3 illustrates an HCI object 102 emitting an optical signal 300 that produces a geometric pattern 302 on a surface 322 comprising an optical sensor 108, according to one embodiment. In various embodiments, the optical signal 300 may comprise a laser light or other light source (e.g., LED), so long as the light source is capable of producing a geometric shape of sufficient definition (e.g., a geometric shape having defined edges). As used herein, the term “light” should be understood broadly as electromagnetic radiation. In various embodiments, the light source may be configured to produce monochromatic light or polychromatic light for the optical signal 300. According to various embodiments, the light source may produce light in the visible spectrum, infrared (IR) light, ultraviolet (UV) light, etc. for the optical signal 300. In some embodiments, the optical signal 300 may be outside of the visible spectrum so as not to interfere with the user experience of using the HCI object 102.

According to the embodiment shown, the optical signal 300 is emitted from the HCI object 102 through point O 301, which may represent the projection center of the HCI object 102. The optical signal 300 is configured to form a divergent beam as it travels further from the HCI object 102, for example. As a result, the cross-sectional size or diameter of the optical signal 300 will increase with distance from the optical aperture or antennae aperture of the HCI object 102. As shown, angle a 304 represents the angle of divergence of the optical signal 300. In the embodiment shown, the optical signal 300 propagates toward the surface 322 of the computing device 100 and forms a geometric pattern 302 on the surface 322. The surface 322 on which the geometric pattern 302 is formed comprises an optical sensor 108, which is configured to detect the geometric pattern 302 formed by the optical signal 300. In various embodiments, the optical sensor 108 may comprise an array of phototransistors that is configured to detect the optical signal 300 and the geometric shape 302. The phototransistors may be small enough that they are not visible to the human eye and do not impede perception of the visual content on the display 104.

An example cross-sectional view 324 of the optical signal 300 is shown to include components 300a-c. In this example, component 300a is shown to be a circular shape, while components 300b and 300c are shown to be lines that intersect at or near the center of component 300a (e.g., similar to crosshairs). The intersection of the components 300b and 300c may form a centerline 306 of the beam of the optical signal 300, for example. When the optical signal 300 beam is incident on the surface 322 of the computing device 100, it forms a geometric pattern 302 comprising components 302a-c, for example. Component 302a is shown in the example to be an ellipse that corresponds to component 300a of the optical signal. Geometrically, if the optical signal 300 beam includes a cone, then the geometric pattern 302 will include a conic section defined by the intersection of the surface of the cone with the surface 322. The conic section may be one of three types depending on the angle of incidence of the optical signal 300: a hyperbola, a parabola, or an ellipse. In the example shown, component 302a is an ellipse defined by a short axis 316, a long axis 318, and a center 314 having coordinates, (x₀, y₀), in the plane defined by the surface 322. Additionally, the ellipse is defined by foci 320a and 320b.

Component 300b of the optical signal 300 is shown to form component 302b of the geometric pattern 302 and component 300c of the optical signal 300 is shown to form component 302c of the geometric pattern 302. Additionally, the centerline 306 projects onto point 308 of the geometric pattern 302.

As mentioned above, in one example embodiment a plurality of phototransistors of the optical sensor 108 may detect the geometric pattern 302 formed by the optical signal 300 such that the computing device 100 has an image or data corresponding to the geometric pattern 302. The computing device 100 is able to calculate geometric parameters of the geometric pattern 302 and use those geometric parameters to determine certain angles and distances corresponding to geometric shapes formed between the HCI object 102 and the surface 322. The computing device 100 is then able to calculate the 3D coordinates 305 of point O 301 of the HCI object 102 using those angles and distances. Further, angle β 310, which represents the angle between the norm 312 of the surface 322 and the centerline 306 of the optical signal 300 beam, may be calculated from the geometric parameters.

Further, the computing device 100 may determine the orientation 303 of the HCI object 102. For example, when the 3D coordinates 305 of point 0 301 are known and the coordinates of point 308 are known, the line 305 that connects point 0 301 and point 308 will have the same orientation as the HCI object 102. As a result, the orientation of the line 305 may be used for at least two variables of the orientation 303 of the HCI object 102 (e.g., pitch and yaw). The roll of the orientation 303 may be calculated from the image or data related to components 302b and 302c. For example, components 302b and 302c will rotate about point 308 as the HCI object 102 rolled. By tracking data related to the location of components 302b and 302c, the roll of the HCI object 102 may be obtained. Therefore, each of the yaw, pitch, and roll of the orientation 303 of the HCI object 102 may be obtained by the computing device. Thus, the pose 307, including the 3D coordinates 305 and the orientation 303, may be recovered by the computing device 100. While FIG. 3 shows an optical signal 300 having a cross-section of a certain shape (e.g., a crosshairs shape), other shapes are contemplated as well and may be practiced with the embodiments described here. The shape shown in FIG. 3 is used merely for illustrative purposes.

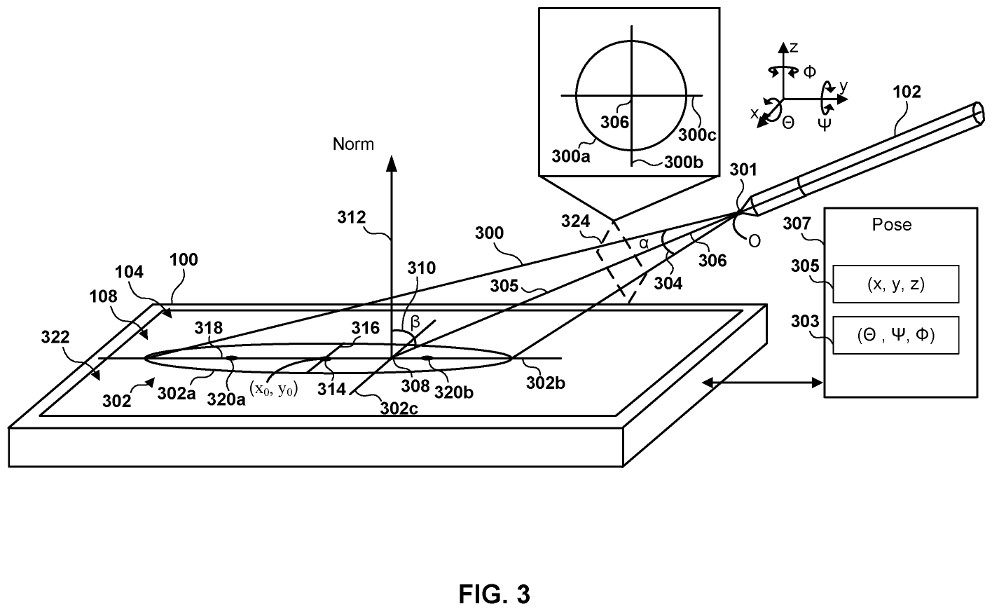

FIGS. 4A-4F illustrate various beam shapes that may be emitted from the HCI object 102 and various resulting geometric patterns formed on surfaces, according to various embodiments. In FIG. 4A, the geometric pattern is shown to be a trapezoidal shape formed by an optical signal with a trapezoidal cross-section. In FIG. 4B, the geometric pattern is shown to be a triangle formed by an optical signal with a triangular cross-section. In FIG. 4C, the geometric pattern is shown to be trapezoidal formed by an optical signal with a square cross-sectional shape. In FIG. 4D, the geometric pattern is shown to be an asymmetrical shape formed by an optical signal with an asymmetrical cross-section. In FIG. 4E, the geometric pattern is shown to have three components including an ellipse and two lines, which are formed by an optical signal with a circular cross-section with two orthogonal lines running through the center of the circle. In FIG. 4F, the geometric pattern is shown to have two components including an ellipse and one line, which are formed by an optical signal with a circular cross-section with one line running through the center of the circle.

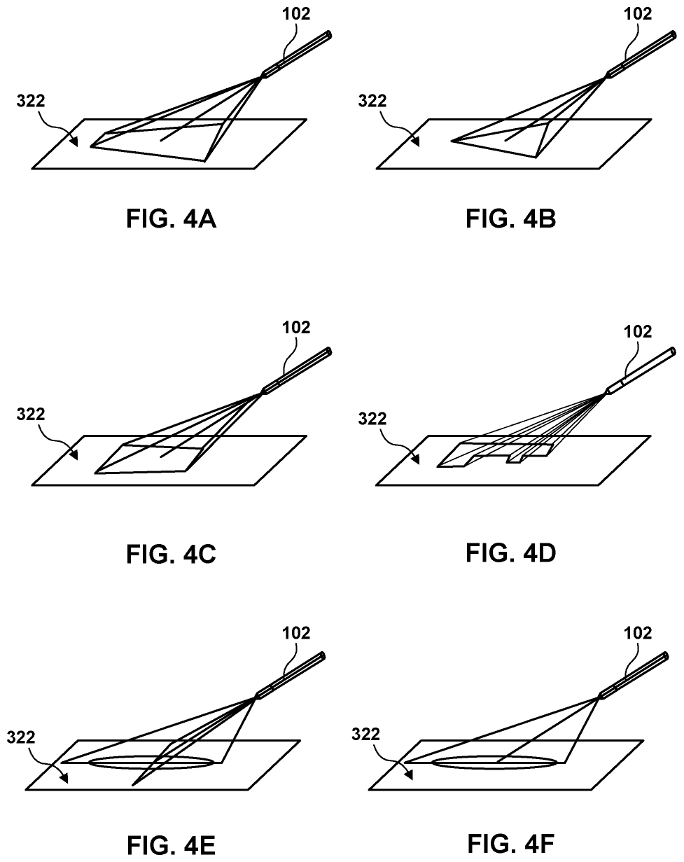

FIG. 5 illustrates a method of recovering the pose of the HCI object by the computing device, according to one embodiment. In this embodiment, the HCI object emits an optical signal that creates a geometric pattern comprising an ellipse and two lines, such as that shown in FIG. 3. At step 500, the computing device receives the 2D coordinates of the phototransistors or other sensors that detect the optical signal. For example, if a phototransistor having arbitrary 2D coordinates of (1, 1) detects the optical signal, the 2D coordinates (1, 1) will be a part of the 2D points input at step 500. At step 512, line fitting is performed on the 2D points input. At step 514, the intersection point of the fitted lines are determined.

At step 502, the computing device performs ellipse fitting of the 2D points input that correspond to the ellipse to extrapolate parameters that represent the ellipse. The ellipse may be represented by the following equation:

Ax²+Bxy+Cy²+Dx+Ey+F=0 (1)

Step 502, for example, extrapolates parameters A-F. In step 504, the ellipse is rotated about the z-axis by θ because the ellipse as formed on the surface may be rotated from the device coordinates. θ is given by:

0=arc tan(B/(A−C))/2 (2)

Next, the new equation of the ellipse is found by calculating the following:

A′=A(cos θ)\hat{ }2+B cosθsinθ+C(sinθ)\hat{ }2 (3)

B′=0 (4)

C′=A(sinθ)\hat{ }2−B cosθsinθ+C(cosθ)\hat{ }2 (5)

D′=D cosθ+E sinθ (6)

E′=−D sinθ+E cosθ (7)

F=F (8)

The resulting rotated ellipse is given by:

A′*x\hat{ }2+C′*y−2+D′*x+E′*y+F=0 (9)

The equation for the ellipse in equation (9) may also be written as:

$$\frac{{( {x}^{′} - {x}_{0}^{′} )}^{2}}{{a}^{2}} + \frac{{( {y}^{′} - {y}_{0}^{′} )}^{2}}{{b}^{2}} = 1 \qquad ( 10 )$$

The center of the rotated ellipse, is given by:

$$\begin{matrix} {x}_{0}^{′} = \frac{- {D}^{′}}{2 {A}^{′}} & ( 11 ) \\ \text{?} = \frac{- {E}^{′}}{2 {C}^{″}} \\ \text{?} \text{indicates text missing or illegible when filed} & ( 12 )\end{matrix}$$

The long axis, a, and the short axis, b, of the ellipse are given by:

$$\begin{matrix}{a}^{2} = \frac{- 4 {F}^{″} {A}^{′} {C}^{″} + {C}^{″} {D}^{′2} + {A}^{′} {E}^{′2}}{4 {A}^{′2} {C}^{″}} & ( 13 ) \\ {b}^{2} = \frac{- 4 {F}^{″} {A}^{′} {C}^{″} + {C}^{′} {D}^{′2} + {A}^{′} {E}^{′2}}{4 {A}^{′2} {C}^{′2}} & ( 14 )\end{matrix}$$

At step 506, the tilt angle is computed. First, the eccentricity, e, of the ellipse may be solved for using the following:

$$e = \frac{\sqrt{{a}^{2} - {b}^{2}}}{a} \qquad ( 15 )$$

Next, the tilt angle, β, of the HCI object is calculated. The tilt angle β is solved for by the following equation:

$$β = {sin}^{- 1} ( e cos \frac{α}{2} ) \qquad ( 16 )$$

In equation (16), α is the angle of divergence, e.g., the angle between a line drawn from the point O and a first point on the circular cross-section and a line drawn from the point O to a second point on the circular cross-section that is farthest away from the first point. a may be a parameter that is a design feature of the HCI object and therefore known.

In step 508, the pose of the HCI object is recovered, for example. The pose of the of the HCI object includes the 3D coordinates of the projection center of the HCI object, point O, as well as the orientation of the HCI object. Point O and the long axis of the ellipse form a triangle with angles 60 , α′, and α″. α′ and α″ are given by the following:

$$\begin{matrix}{α}^{′} = {180}^{∘} - \frac{α}{2} - ( 9 {0}^{∘} - β ) & ( 17 ) \\ {α}^{″} = 18 {0}^{∘} - \frac{α}{2} - ( 9 {0}^{∘} + β ) & ( 18 )\end{matrix}$$

The height of the triangle is, which is the z-coordinate of point O, is given by:

Oz=2*b*sin(α1)*sin(α2)/sin(α) (19)

The y-coordinate of point O is given by one of following equations depending on where the line intersection point is:

O_{y}=−(O_{z}*cotan(α″)+b)+y₀ (20)

O_{y}=−Oz*cotan(α″)+b+y′₀ (21)

The x-coordinate of point O is simply Oₓ=x′₀. The coordinate of point O are then rotated back to sensor coordinates at step 510.

As such, the 3D position of the point O of the HCI object may be recovered. The roll of the HCI object may further be determined in a number of ways. For example, in one embodiment, the angular distance of the lines of the geometric pattern away from the long and short axes of the ellipse may be used as a measure of the amount of roll of the HCI object. In other embodiments, the angular distance that one or more of the lines of the geometric pattern may be tracked over time to determine roll. For example, if a particular line segment of one of the lines of the geometric pattern is tracked as rotating by 90° in a clockwise direction, then it can be deduced that the HCI object has been rolled by 90° in a clockwise direction. As a result, the pose of the HCI object may be determined at step 510 for six degrees of freedom of the HCI object.

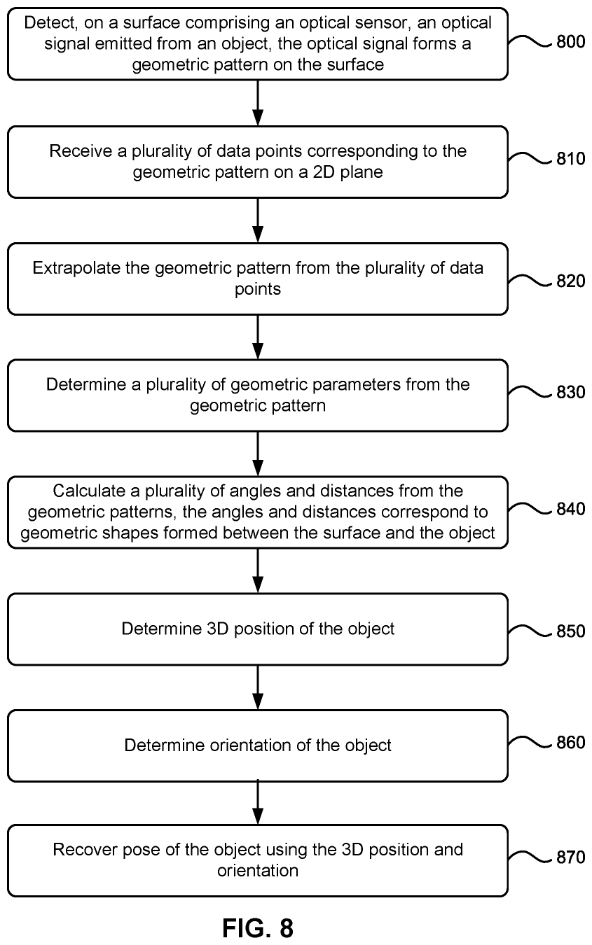

At step 516, an inertial measurement unit (IMU) measurement that is disposed in or about the HCI object may be obtained from the HCI object. It is envisioned that the IMU measurement may be combined with the pose recovered at step 510 for correcting or refining the pose of step 512. The IMU may include one or more of an accelerometer, a gyroscope, or a magnetometer, which can provide data related to the orientation of the HCI object (e.g., pitch, yaw, and roll). The IMU measurement may be communicated to the computing device via any wireless communication protocol. Moreover, the IMU measurement may be itself encoded in the optical signal emitted by the HCI object. For example, the optical signal may be pulsated so as to encode information in the signal. This is described in more detail with reference to FIG. 9.

The pose data is then fed into a Kalman filter 518 before becoming the final pose 520. The Kalman filter 518 is used to filter out statistical noise and inaccuracies associated with the determination of the pose.

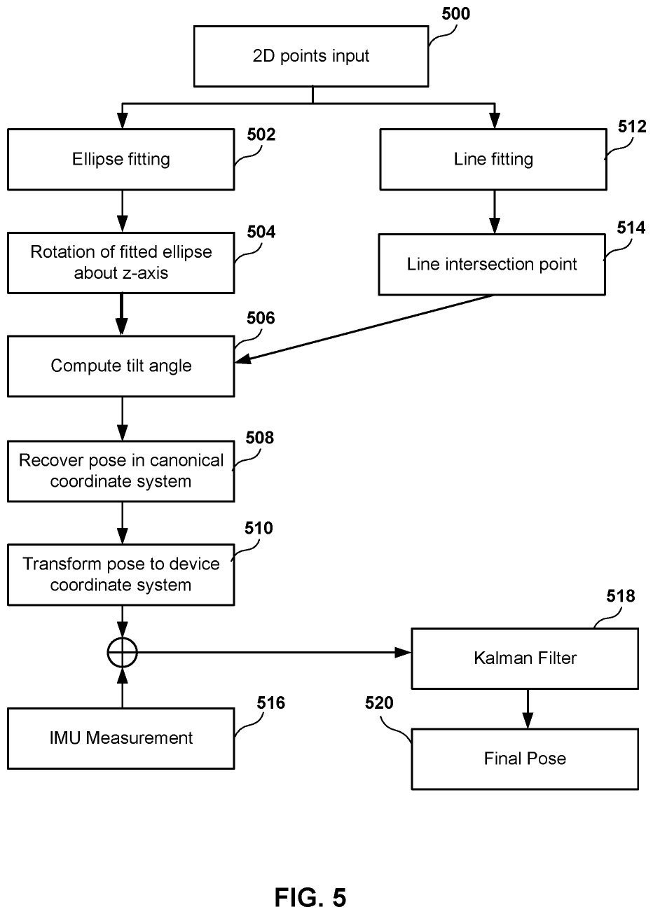

FIG. 6 illustrates how the optical sensor 108 comprising an array of phototransistors is used to extrapolate the geometric pattern formed on the optical sensor, according to one embodiment. The computing device 100 is shown to include a display 104 on which an array 600 of photosensors such as phototransistors may be disposed. In certain embodiments, the array 600 of photosensors may be implemented as a grid 604 of photosensors. In various embodiments, the grid 604 may comprise a network of lines either parallel or orthogonal to one another to form a series of squares or rectangles. In certain embodiments, the grid 604 may comprise evenly spaced lines or unevenly spaced lines. It is contemplated that each line of grid 604 may comprise a row (e.g., single file) of photosensors that are even spaced from each other. A magnified view 606 shows individual photosensors arranged single file along lines of the grid 604. Segments 608a and 608b are shown to include a series of individual photosensors that are spaced evenly from each other in the magnified view 606.

According to the present disclosure, the arrangement of the photosensors in grid 604 may be referred to as a “sparse grid” due to the decreased number of photosensors per unit area compared to image sensors used conventional image capture. In comparison, an image sensor such as charge-coupled device (CCD) used in digital cameras and other imaging does not comprise a sparse grid of metal-oxide-semiconductor (MOS) capacitors, each representing a pixel. For example, a 1000×1000 pixel CCD image will contain 1,000,000 pixels. In contrast, a sparse grid may comprise anywhere between 100-100,000 pixels, or between 1,000-10,000 pixels, or between 2,000 and 5,000 pixels. This reduction in pixel data reduces the overall processing time and cost for pose recovery of the HCI object.

For example, area 614 is shown in the magnified view 606 to include 8 “rows” and 8 “columns” of photosensors, where each “row” comprises one photosensor and each and “column” comprises one photosensor. For example, row 616 has one photosensor from segment 608a and column 618 has one photosensor from segment 608b. Thus, area 614 is inclusive of 8 photosensors from segment 608a and 8 photosensors from segment 608b, with one photosensor being shared between the two segments 608a and 608b. The total number of photosensors in area 614 is 15 photosensors. In a CCD camera, an 8×8 area of photosensors would have 64 photosensors total. The reduction in photosensors in a sparse grid is contemplated to reduce bandwidth and processing time without sacrificing accuracy because geometric shapes (e.g., ellipses and lines) may be fitted accurately from fewer data points.

A “sparse grid” may thus be described as that in which the total number pixels or photosensors in some unit area as defined by m rows and n columns is less than m×n.

It is further contemplated that the photosensors are sensitive to a narrow band of the electromagnetic spectrum and generate a binary output. This is also in contrast to a CCD camera, in which each photosensor is sensitive to a wide range of the electromagnetic spectrum and generates output represented by multiple bits per pixel or photosensor. By using photosensors that are tuned for the optical signal wavelength, the amount of raw data that is to be processed for pose recovery is reduced.

In certain embodiments, the photosensors may act as or be implemented in accordance with an event camera. When implemented as an event camera, each of the photosensors of the array 600 operates independently and asynchronously. Each of the photosensors of the array 600 will generate an output resulting from changes in the detection of the optical signal. As a result, the photosensors may generate an output only when a change to the presence or absence of the optical signal occurs. This provides higher temporal resolution to the optical sensor 108 as well as the pose recovery processing time.

Continuing with FIG. 6, the geometric pattern 602 that is formed on the optical sensor 108 includes an ellipse 601, a first line 603, and a second line 605. The geometric pattern 602 is detected by photosensors of the grid 604 where the geometric pattern intersects the grid 604. The output of the photosensors is represented by 2D data points 610. For example, the 2D data points 601a correspond to the ellipse 601, while the 2D data points 603a correspond to the first line 603 and 2D data points 605a correspond to the second line 605. The geometric shape 612 is then extrapolated (e.g., fitted) from the 2D data points 610. For example, 2D data points 601a are fitted with ellipse 601b, while 2D data points 603a are fitted with first line 603b and 2D data points 605a are fitted with second line 605b. In this manner, the geometric shape 602 that is formed on the optical sensor 108 is determined by the computing device 100.

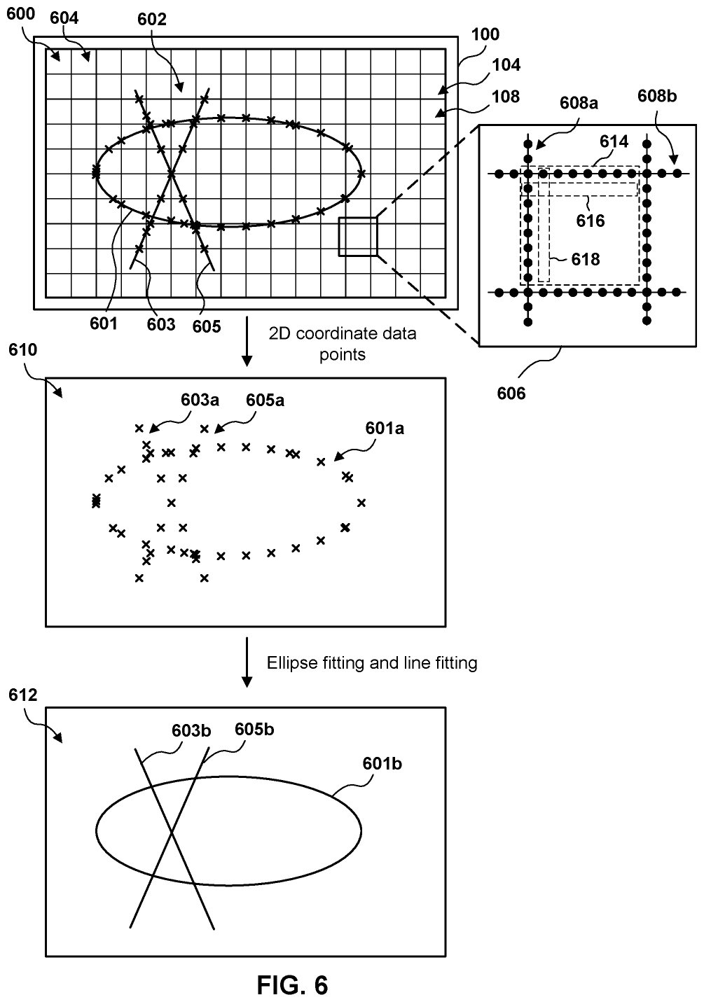

FIG. 7 illustrates components of an HCI object 102 that emits an optical signal 700 and that may be used with the present embodiment, according to one embodiment. The HCI object 102 includes an optical radiation source 702 that may emit any type of electromagnetic radiation so long as a sufficiently defined geometric pattern is formed when it is incident on a surface. A sufficiently defined geometric pattern is one in which the line and shape fitting may be performed with less error or uncertainty. In certain embodiments, the optical radiation source 702 may comprise a laser diode such as an infrared laser diode. In other embodiments, the optical radiation source 702 may comprise a light-emitting diode (LED).

The optical radiation source 702 is shown to form a beam 704 that travels through a diffractive optical element (DOE) 706, which serves to shape the beam 704 and diverge the beam 704. The DOE 706 has a surface with a microstructure that propagates photons of the beam 704 in a defined and desired manner. The DOE 706 may be chosen to achieve the desired shape or cross-section of the optical signal 700.

As shown in FIG. 7, the DOE 706 shapes beam 706 into a first component 708 and a second component 710. The first component 708 may comprise a circular cross section such as that shown in FIG. 3, while the second component 710 may have a line in its cross-section. Additionally, the DOE 706 serves to diffract and/or refract light waves of the beam 704 for introducing divergence to the beam 704. As a result, the optical signal 700 has a divergence in which the diameter of a cross-section of the beam increases with distance away from the DOE 706. Additional optical components such as lenses, mirrors, slits, filters, polarizers, beam splitters, gratings, etc., may be used to further shape the optical signal 718 into the desired form.

The HCI object 102 is also shown to include an IMU 712, the data from which may be communicated to the computing device via communication module 716. The IMU 712 may provide orientation measurements to the computing device in some embodiments. In these and other embodiments, the IMU 712 may also provide data related to movement of the HCI object 102. The communication module 716 may communicate with the computing device (not shown) via any suitable wireless protocol, such as Bluetooth, Wi-Fi, near field communication (NFC), among many others. Additionally, or alternatively, the output of the IMU 712 may be communicated to the computing device via encoding of the optical signal 700. For example, the measurements of the IMU 712 may be converted into a binary signal by optical signal encoding module 714. The optical signal 700 may then be pulsated according to the optical signal encoding module 714 using an optical encoder 718. The optical encoder 718 may be disposed between the optical radiation source 702 and the DOE 706, according to some embodiments. In other embodiments, the optical encoder 718 may be placed downstream of the DOE 706. In still other embodiments, the optical encoding may take place at the optical radiation source 702, where the beam 704 may be pulsated according to the optical signal encoding module 714.

In various embodiments, the optical signal encoding module 714 may also encode for information related to the shape of the optical signal 700. For example, in various embodiments, the shape of the optical signal 700 may comprise multiple components such as what is shown in FIG. 3. In these embodiments, the multiple components may be emitted by the HCI object 102 simultaneously or sequentially. For sequentially emitted components, a first component may be emitted for a period of time before the second component is emitted and the first component is no longer emitted and so on. In these embodiments, information related to which components (e.g., what shape the component is) may be encoded in the optical signal. The computing device may use this information to more efficiently and accurately perform line fitting of the components because it knows what to look for. In various embodiments, both IMU 712 measurements and information related to the shape of the optical signal 700 may be encoded in the optical signal 700.

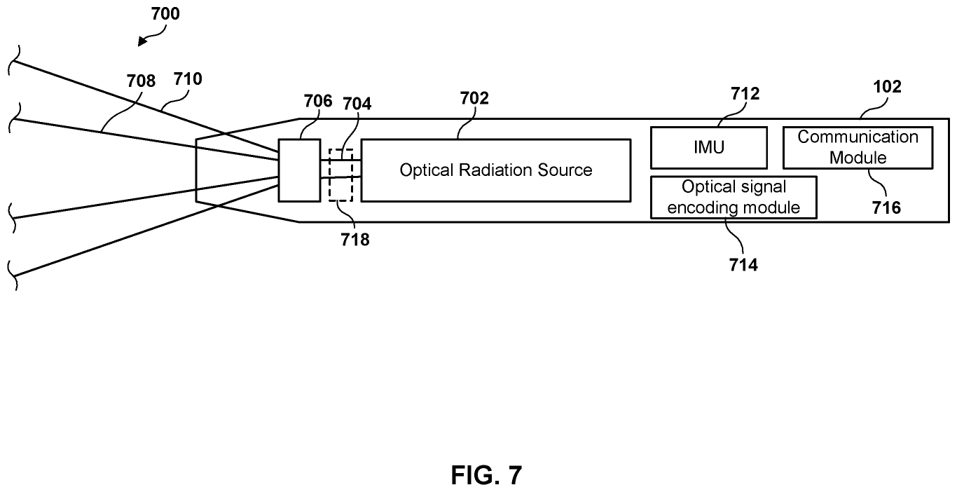

FIG. 8 illustrates a method of recovering the pose of an HCI object such as a 3D stylus, according to one embodiment. At step 800, an optical signal forming a geometric pattern on a surface is detected by an optical sensor of the surface. The optical sensor may be disposed on top of display of a computing device in a manner that does not interfere with the user's visual experience. The optical sensor may comprise a sparse grid of phototransistors. At step 810, a plurality of data points corresponding to the geometric pattern on a 2D plane are received. For example, when a given phototransistor that detects the optical signal produces an output, the 2D coordinates of the phototransistor are known and will be a part of the data points that correspond to the geometric pattern. The data points are then used to extrapolate the geometric pattern in step 820. This is done, in some embodiments, using line fitting software. Next, a plurality of geometric parameters of the geometric pattern are determined at step 830. For example, if the geometric pattern is defined by an ellipse, step 830 will serve to determine the parameters shown in equations (1)-(12).

Step 840 of the method serves to calculate a plurality of angles and distances from the geometric pattern, the angles and distances corresponding to geometric shapes formed between the surface and the HCI object. For example, one of the possible geometric shapes include the triangle formed by the long-axis of the ellipse and the projection center point 0. For example, at step 840, certain angles and coordinates from equations (13)-(15), (17), and (18) may be calculated. Using the angles and distances calculated in step 840, the 3D position of the HCI object is calculated at step 850. For example, the x, y, and z-coordinates of equations (19)-(21) may be calculated in step 850. In step 860, the orientation of the HCI object is determined. For example, equation (16) may be solved in step 860. Finally, in step 870, the pose including the 3D coordinates and orientation of the HCI object are determined.

### EXAMPLE

The following is an example of code for a mathematical computing environment that can carry out certain steps of the method shown in FIG. 8:
% Ax\hat{ }2+Bxy+Cy\hat{ }2+Dx+Ey+F=0
A=10;
B=2;
C=1;
D=50;
E=40;
F=−100;
alpha=20;
theta=atand(B/(A−C))/2% rotation around Z
A1=A*cosd(theta)\hat{ }2+B*cosd(theta)*sind(theta)+C*sind(theta)\hat{ }2
B1=0
C1=A*sind(theta)\hat{ }2−B*cosd(theta)*sind(theta)+C*cosd(theta)\hat{ }2
D1=D*cosd(theta)+E*sind(theta)
E1=−D*sind(theta)+E*cosd(theta)
F1=F
syms x y;
eqn=A*x\hat{ }2+B*x*y+C*y\hat{ }2+D*x+E*y+F==0;
eqn1=A1*x\hat{ }2+B1*x*y+C1*y\hat{ }2+D1*x+E1*y+F1==0;
solx=solve(eqn, y);
solx1=solve(eqn1, y);
fplot(solx)
axis equal
hold on;
% axis([−20 20 −20 20])
% fplot(solx1)
plot(0,0,′o′);
x0=−D1/(2*A1)
y0=−E1/(2*C1)
a=sqrt((−4*F1*A1*C1+C1*D1\hat{ }2+A1*E1\hat{ }2)/(4*A1\hat{ }2*C1))
b=sqrt((−4*F1*A1*C1+C1*D1\hat{ }2+A1*E1\hat{ }2)/(4*A1*C1\hat{ }2))
% eccentricity:
e=sqrt(b\hat{ }2−a\hat{ }2)/b
% tilt angle:
tilt=asind(e*cosd(alpha/2))
beta1=180−alpha/2−(90+tilt)
beta2=180−alpha/2−(90-tilt)
o_x=0
o_z=sind(beta1)*sind(beta2)*2*b/sind(alpha)
o_y=−(o_z*cotd(beta2)+b) % +/−depends on where is the line intersection.
% or:
o_y=b−o_z*cotd(beta1)
O_x=o_x+x0
O_y=o_y+y0
O_z=o_z
% plot(O_x,O_y,′x′);
P=[cosd(theta), −sind(theta), 0; sind(theta),cosd(theta),0;0,0,1]*[O_x,O_y,O_z]′
plot3(P(1),P(2),P(3),′x′);

The above-referenced code returns the 3D coordinates of: Px=0.8449; Py=−12.6574; Pz=9.1448.

FIG. 9 shows how the optical signal emitted by the HCI object may be used to encode information to be receive by the computing device via the optical sensor, according to one embodiment. According to FIG. 9, a plot 900 shows the intensity of the optical signal as a function of time. In period 902, a first component 910 of the optical signal is being emitted by the HCI object 102. During the period 902 in which the first component 910 is emitted, the intensity of the optical signal of the first component may be modulated in the manner shown in the plot 900. The pattern of modulation may correspond to code that the optical sensor detects and the computing device can read. For example, the pattern shown in plot 900 that corresponds to period 902 may represent “ellipse,” and as such configure the computing device to selectively detect an ellipse (e.g., use an ellipse-fitting model). During period 904, the optical signal intensity pattern changes from that of period 902 and may encode for “line” corresponding to a second component 912 of the optical signal. Likewise, the signal intensity pattern at period 906 may encode for “line” corresponding to a third component 914 of the optical signal. The HCI object 102 may cycle between the various components in a matter of fractions of second so as not to interfere with the pose recovery processes of the HCI object. As mentioned above, IMU measurements may be encoded in the optical signal as well. IMU measurements information may be encoded and emitted in between encodings for shape, e.g., between periods 902, 904, and 906.

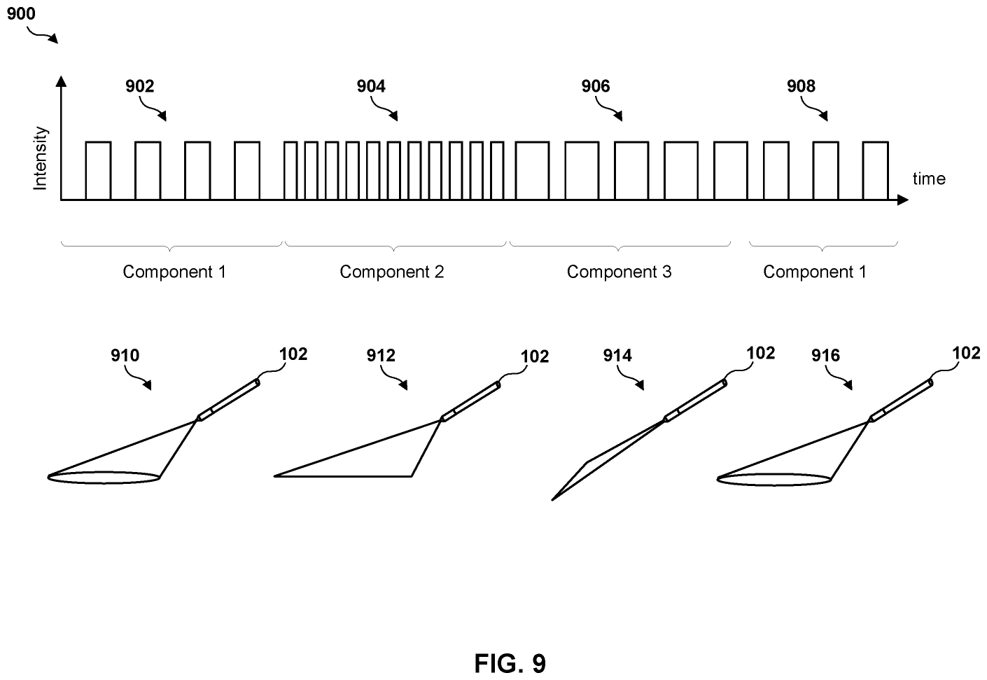

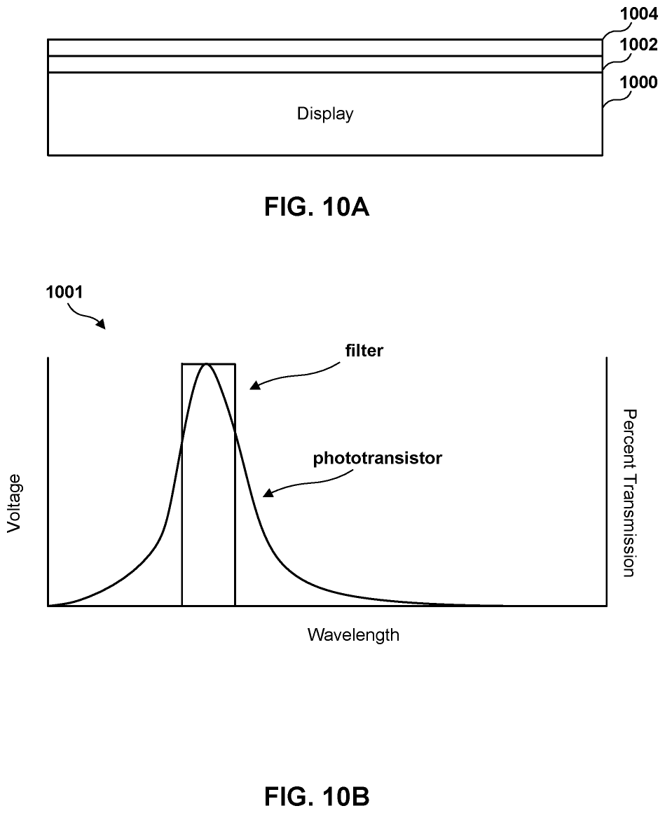

FIG. 10A shows a cross-sectional view of a portion of a computing device used for HCI in 3D, according to one embodiment. The cross-sectional view includes a display 1000, a layer 1002 of phototransistors, and a bandpass filter 1004. The layer 1002 may be thin enough and the phototransistors transparent enough so as to be undetectable by the human eye. The phototransistors may be organic or inorganic phototransistors and may be printed on layer 1002, for example. In some embodiments, the phototransistors may produce a voltage in response to a certain band of light, with the optical signal being within the band. A bandpass filter 1004 may be disposed on the layer 1002 of phototransistors to attenuate ambient light from reaching the phototransistors.

FIG. 10B shows a plot 1001 of optical sensor sensitivity and transmission properties of a filter that may be installed on top of the optical sensor, according to one embodiment. The plot 1001 shows the sensitivity of a particular phototransistor as a function of the wavelength of light. The filter is shown to pass wavelengths that correspond to the sensitivity curve of the phototransistor, for example. In this fashion, the effect of ambient light on the phototransistors is lessened.

### Hardware

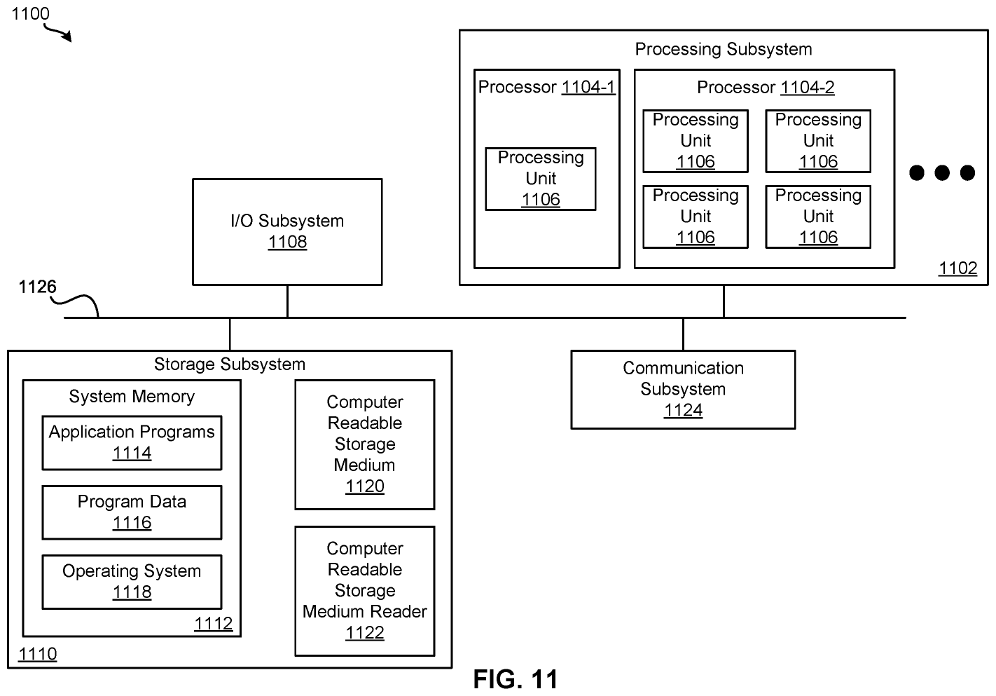

FIG. 11 illustrates an exemplary computer system 1100 for implementing various embodiments described above. For example, computer system 1100 may be used to implement computing system 100. Computer system 1100 may be a desktop computer, a laptop, a server computer, a tablet, a phone, a smart TV, or any other type of computer system or combination thereof. Computer system 1100 can implement many of the operations, methods, and/or processes described above. As shown in FIG. 11, computer system 1100 includes processing subsystem 1102, which communicates, via bus subsystem 1126, with input/output (I/O) subsystem 1108, storage subsystem 1110 and communication subsystem 1124.

Bus subsystem 1126 is configured to facilitate communication among the various components and subsystems of computer system 1100. While bus subsystem 1126 is illustrated in FIG. 11 as a single bus, one of ordinary skill in the art will understand that bus subsystem 1126 may be implemented as multiple buses. Bus subsystem 1126 may be any of several types of bus structures (e.g., a memory bus or memory controller, a peripheral bus, a local bus, etc.) using any of a variety of bus architectures. Examples of bus architectures may include an Industry Standard Architecture (ISA) bus, a Micro Channel Architecture (MCA) bus, an Enhanced ISA (EISA) bus, a Video Electronics Standards Association (VESA) local bus, a Peripheral Component Interconnect (PCI) bus, a Universal Serial Bus (USB), etc.

Processing subsystem 1102, which can be implemented as one or more integrated circuits (e.g., a conventional microprocessor or microcontroller), controls the operation of computer system 1100. Processing subsystem 1102 may include one or more processors 1104. Each processor 1104 may include one processing unit 1106 (e.g., a single core processor such as processor 1104-1) or several processing units 1106 (e.g., a multicore processor such as processor 1104-2). In some embodiments, processors 1104 of processing subsystem 1102 may be implemented as independent processors while, in other embodiments, processors 1104 of processing subsystem 1102 may be implemented as multiple processors integrate into a single chip or multiple chips. Still, in some embodiments, processors 1104 of processing subsystem 1102 may be implemented as a combination of independent processors and multiple processors integrated into a single chip or multiple chips.

In some embodiments, processing subsystem 1102 can execute a variety of programs or processes in response to program code and can maintain multiple concurrently executing programs or processes. At any given time, some or all of the program code to be executed can reside in processing subsystem 1102 and/or in storage subsystem 1110. Through suitable programming, processing subsystem 1102 can provide various functionalities, such as the functionalities described above by reference to FIGS. 5, 6, and 8, etc.

I/O subsystem 1108 may include any number of user interface input devices and/or user interface output devices. User interface input devices may include a keyboard, pointing devices (e.g., a mouse, a trackball, etc.), a touchpad, a touch screen incorporated into a display, a scroll wheel, a click wheel, a dial, a button, a switch, a keypad, audio input devices with voice recognition systems, microphones, image/video capture devices (e.g., webcams, image scanners, barcode readers, etc.), motion sensing devices, gesture recognition devices, eye gesture (e.g., blinking) recognition devices, biometric input devices, and/or any other types of input devices.

User interface output devices may include visual output devices (e.g., a display subsystem, indicator lights, etc.), audio output devices (e.g., speakers, headphones, etc.), etc. Examples of a display subsystem may include a cathode ray tube (CRT), a flat-panel device (e.g., a liquid crystal display (LCD), a plasma display, etc.), a projection device, a touch screen, and/or any other types of devices and mechanisms for outputting information from computer system 1100 to a user or another device (e.g., a printer).

As illustrated in FIG. 11, storage subsystem 1110 includes system memory 1112, computer-readable storage medium 1120, and computer-readable storage medium reader 1122. System memory 1112 may be configured to store software in the form of program instructions that are loadable and executable by processing subsystem 1102 as well as data generated during the execution of program instructions. In some embodiments, system memory 1112 may include volatile memory (e.g., random access memory (RAM)) and/or non-volatile memory (e.g., read-only memory (ROM), programmable read-only memory (PROM), erasable programmable read-only memory (EPROM), electrically erasable programmable read-only memory (EEPROM), flash memory, etc.). System memory 1112 may include different types of memory, such as static random access memory (SRAM) and/or dynamic random access memory (DRAM). System memory 1112 may include a basic input/output system (BIOS), in some embodiments, that is configured to store basic routines to facilitate transferring information between elements within computer system 1100 (e.g., during start-up). Such a BIOS may be stored in ROM (e.g., a ROM chip), flash memory, or any other type of memory that may be configured to store the BIOS.

As shown in FIG. 11, system memory 1112 includes application programs 1114, program data 1116, and operating system (OS) 1118. OS 1118 may be one of various versions of Microsoft Windows, Apple Mac OS, Apple OS X, Apple macOS, and/or Linux operating systems, a variety of commercially-available UNIX or UNIX-like operating systems (including without limitation the variety of GNU/Linux operating systems, the Google Chrome® OS, and the like) and/or mobile operating systems such as Apple iOS, Windows Phone, Windows Mobile, Android, BlackBerry OS, Blackberry 10, and Palm OS, WebOS operating systems.

Computer-readable storage medium 1120 may be a non-transitory computer-readable medium configured to store software (e.g., programs, code modules, data constructs, instructions, etc.). Many of the components and/or processes described above may be implemented as software that when executed by a processor or processing unit (e.g., a processor or processing unit of processing subsystem 1102) performs the operations of such components and/or processes. Storage subsystem 1110 may also store data used for, or generated during, the execution of the software.

Storage subsystem 1110 may also include computer-readable storage medium reader 1122 that is configured to communicate with computer-readable storage medium 1120. Together and, optionally, in combination with system memory 1112, computer-readable storage medium 1120 may comprehensively represent remote, local, fixed, and/or removable storage devices plus storage media for temporarily and/or more permanently containing, storing, transmitting, and retrieving computer-readable information.

Computer-readable storage medium 1120 may be any appropriate media known or used in the art, including storage media such as volatile, non-volatile, removable, non-removable media implemented in any method or technology for storage and/or transmission of information. Examples of such storage media includes RAM, ROM, EEPROM, flash memory or other memory technology, compact disc read-only memory (CD-ROM), digital versatile disk (DVD), Blu-ray Disc (BD), magnetic cassettes, magnetic tape, magnetic disk storage (e.g., hard disk drives), Zip drives, solid-state drives (SSD), flash memory card (e.g., secure digital (SD) cards, CompactFlash cards, etc.), USB flash drives, or any other type of computer-readable storage media or device.

Communication subsystem 1124 serves as an interface for receiving data from, and transmitting data to, other devices, computer systems, and networks. For example, communication subsystem 1124 may allow computer system 1100 to connect to one or more devices via a network (e.g., a personal area network (PAN), a local area network (LAN), a storage area network (SAN), a campus area network (CAN), a metropolitan area network (MAN), a wide area network (WAN), a global area network (GAN), an intranet, the Internet, a network of any number of different types of networks, etc.). Communication subsystem 1124 can include any number of different communication components. Examples of such components may include radio frequency (RF) transceiver components for accessing wireless voice and/or data networks (e.g., using cellular technologies such as 2G, 3G, 4G, 5G, etc., wireless data technologies such as Wi-Fi, Bluetooth, ZigBee, etc., or any combination thereof), global positioning system (GPS) receiver components, and/or other components. In some embodiments, communication subsystem 1124 may provide components configured for wired communication (e.g., Ethernet) in addition to or instead of components configured for wireless communication.

One of ordinary skill in the art will realize that the architecture shown in FIG. 11 is only an example architecture of computer system 1100, and that computer system 1100 may have additional or fewer components than shown, or a different configuration of components. The various components shown in FIG. 11 may be implemented in hardware, software, firmware or any combination thereof, including one or more signal processing and/or application specific integrated circuits.

### FURTHER EXAMPLES

Each of these non-limiting examples may stand on its own, or may be combined in various permutations or combinations with one or more of the other examples.

Example 1 is a method (e.g., executing on a computing device or embodied in instructions of a computer-readable medium) comprising: detecting, on a surface comprising an optical sensor, an optical signal emitted from an object, the optical signal forming a geometric pattern on the surface; and determining, based on the geometric pattern formed on the surface, a three-dimensional position of the object relative to the surface.

In Example 2, the subject matter of Example 1 optionally includes further comprising: determining a plurality of angles and distances from the geometric pattern, wherein the angles and distances correspond to geometric shapes formed between the object and the surface defined by the geometric pattern, and wherein said determining the three-dimensional position is based on said angles and distances.

In Example 3, the subject matter of Examples 1-2 optionally includes further comprising: receiving, in response to the detecting, a plurality of data points corresponding to the geometric pattern on a 2-dimensional (2D) plane.

In Example 4, the subject matter of Examples 1-3 optionally includes further comprising: extrapolating the geometric pattern from the plurality of data points.

In Example 5, the subject matter of Examples 1-4 optionally includes further comprising: determining a plurality of geometric parameters from the geometric pattern.

In Example 6, the subject matter of Examples 1-5 optionally includes further comprising: calculating a plurality of angles and distances from the geometric parameters, wherein said determining the three-dimensional position is based on said angles and distances.

In Example 7, the subject matter of Examples 1-6 optionally includes wherein the geometric pattern comprises an ellipse.

In Example 8, the subject matter of Examples 1-7 optionally includes wherein the geometric pattern comprises one or more lines.

In Example 9, the subject matter of Examples 1-8 optionally includes wherein the optical sensor of the surface includes an array of phototransistors, wherein the phototransistors are configured to detect the geometric pattern.

In Example 10, the subject matter of Examples 1-9 optionally includes wherein the array of phototransistors is configured in a grid.

In Example 11, the subject matter of Examples 1-10 optionally includes wherein the geometric pattern is a continuous geometric pattern, the phototransistors sensing intersections of the continuous geometric pattern and the grid.

In Example 12, the subject matter of Examples 1-11 optionally includes wherein the geometric pattern comprises a plurality of geometric components.

In Example 13, the subject matter of Examples 1-12 optionally includes wherein the geometric components comprise an ellipse and plurality of lines.

In Example 14, the subject matter of Examples 1-13 optionally includes wherein the plurality of geometric components is received on the surface simultaneously.

In Example 15, the subject matter of Examples 1-14 optionally includes wherein each of the plurality of geometric components are received on the surface at different time periods.

In Example 16, the subject matter of Examples 1-15 optionally includes further comprising: determining, based on the geometric pattern, an orientation of the object relative to the surface.

In Example 17, the subject matter of Examples 1-16 optionally includes wherein the object is a stylus.

Example 18 is a computing device, comprising: an optical sensor comprising a surface, the optical sensor configured to detect, on the surface, an optical signal emitted from an object, the optical signal forming a geometric pattern on the surface; and a processor is configured to determine, based on the geometric pattern, a three-dimensional position of the object relative to the surface.

In Example 19, the subject matter of example 18 optionally includes wherein the processor is further configured for determining a plurality of angles and distances from the geometric pattern, wherein the angles and distances correspond to geometric shapes formed between the object and the surface defined by the geometric pattern, and wherein said determining the three-dimensional position is based on said angles and distances.

Example 20 is a non-transitory machine-readable medium having executable instructions to cause one or more processing units to perform a method to determine a three-dimensional position of an object, the method comprising: detecting, on a surface comprising an optical sensor, an optical signal emitted from an object, the optical signal forming a geometric pattern on the surface; and determining, based on the geometric pattern formed on the surface, the three-dimensional position of the object relative to the surface.

Example 21 is at least one machine-readable medium including instructions for operation of a computing system, which when executed by a machine, cause the machine to perform operations of any of the methods of Examples 1-17.

Example 22 is an apparatus comprising means for performing any of the methods of Examples 1-17.

The above description illustrates various embodiments of the present disclosure along with examples of how aspects of the particular embodiments may be implemented. The above examples should not be deemed to be the only embodiments, and are presented to illustrate the flexibility and advantages of the particular embodiments as defined by the following claims. Based on the above disclosure and the following claims, other arrangements, embodiments, implementations and equivalents may be employed without departing from the scope of the present disclosure as defined by the claims.

What is claimed is:

1. A method, comprising:
detecting, on a surface comprising an optical sensor, an optical signal emitted from an object, the optical signal forming a geometric pattern on the surface; and
determining, based on the geometric pattern formed on the surface, a three-dimensional position of the object relative to the surface.

2. The method of claim 1, further comprising:
determining a plurality of angles and distances from the geometric pattern, wherein the angles and distances correspond to geometric shapes formed between the object and the surface defined by the geometric pattern, and wherein said determining the three-dimensional position is based on said angles and distances.

3. The method of claim 1, further comprising:
receiving, in response to the detecting, a plurality of data points corresponding to the geometric pattern on a 2-dimensional (2D) plane.

4. The method of claim 3, further comprising:
extrapolating the geometric pattern from the plurality of data points.

5. The method of claim 4, further comprising:
determining a plurality of geometric parameters from the geometric pattern.

6. The method of claim 5, further comprising:
calculating a plurality of angles and distances from the geometric parameters, wherein said determining the three-dimensional position is based on said angles and distances.

7. The method of claim 1, wherein the geometric pattern comprises an ellipse.

8. The method of claim 1, wherein the geometric pattern comprises one or more lines.

9. The method of claim 1, wherein the optical sensor of the surface includes an array of phototransistors, wherein the phototransistors are configured to detect the geometric pattern.

10. The method of claim 9, wherein the array of phototransistors is configured in a grid.

11. The method of claim 10, wherein the geometric pattern is a continuous geometric pattern, the phototransistors sensing intersections of the continuous geometric pattern and the grid.

12. The method of claim 1, wherein the geometric pattern comprises a plurality of geometric components.

13. The method of claim 12, wherein the geometric components comprise an ellipse and plurality of lines.

14. The method of claim 12, wherein the plurality of geometric components is received on the surface simultaneously.

15. The method of claim 12, wherein each of the plurality of geometric components are received on the surface at different time periods.

16. The method of claim 1, further comprising:
determining, based on the geometric pattern, an orientation of the object relative to the surface.

17. The method of claim 1, wherein the object is a stylus.

18. A computing device, comprising:
an optical sensor comprising a surface, the optical sensor configured to detect, on the surface, an optical signal emitted from an object, the optical signal forming a geometric pattern on the surface; and
a processor is configured to determine, based on the geometric pattern, a three-dimensional position of the object relative to the surface.

19. The computing device of claim 19, wherein the processor is further configured for determining a plurality of angles and distances from the geometric pattern, wherein the angles and distances correspond to geometric shapes formed between the object and the surface defined by the geometric pattern, and wherein said determining the three-dimensional position is based on said angles and distances.

20. A non-transitory machine-readable medium having executable instructions to cause one or more processing units to perform a method to determine a three-dimensional position of an object, the method comprising:
detecting, on a surface comprising an optical sensor, an optical signal emitted from an object, the optical signal forming a geometric pattern on the surface; and
determining, based on the geometric pattern formed on the surface, the three-dimensional position of the object relative to the surface.

21. The non-transitory machine-readable medium of claim 20, wherein the method further comprises:
determining a plurality of angles and distances from the geometric pattern, wherein the angles and distances correspond to geometric shapes formed between the object and the surface defined by the geometric pattern, and wherein said determining the three-dimensional position is based on said angles and distances.
